(19) United States
(12) Patent Application Publication
(10) Pub. No.: US 2025/0168613 A1
(43) Pub. Date: May 22, 2025

(54) METHODS, SYSTEMS, AND MEDIA FOR CONNECTING USERS TO ACCIDENT SERVICES

(71) Applicants: Guven Uzun, Marina Del Rey, CA (US); Osman Alexander Uzun, Marina Del Rey, CA (US); Aydin Atilla Uzun, Marina Del Rey, CA (US)

(72) Inventors: Guven Uzun, Marina Del Rey, CA (US); Osman Alexander Uzun, Marina Del Rey, CA (US); Aydin Atilla Uzun, Marina Del Rey, CA (US)

(21) Appl. No.: 18/615,305

(22) Filed: Mar. 25, 2024

Related U.S. Application Data
(60) Provisional application No. 63/629,038, filed on Sep. 15, 2023.
(60) Provisional application No. 63/629,103, filed on Sep. 18, 2023.
(60) Provisional application No. 63/629,113, filed on Sep. 21, 2023.

(51) Int. Cl. H04W 4/90; H04W 4/02; H04W 4/024; H04W 4/029

(52) U.S. Cl. CPC H04W 4/90; H04W 4/024; H04W 4/027; H04W 4/029

(57) ABSTRACT

Systems, methods, and media for connecting users to accident services are disclosed herein. The systems can include memory and one or more processors configured at least to generate sensor information based at least on one or more outputs of one or more sensors of a user device, the sensor information including accelerometer information; in response to generating the sensor information, determine that the user device was involved in a collision based at least on the sensor information; determine geographical location information of the user device; in response to determining that the user device was involved in the collision and in response to determining geographical location information of the user device, cause at least contact information for one or more service providers to be presented on the user device based at least in part on the geographical location information of the user device.

### CROSS-REFERENCE TO RELATED APPLICATION

This application claims priority to and the benefit of U.S. Provisional Patent Application No. 63/629,038 filed on Sep. 15, 2023, U.S. Provisional Patent Application No. 63/629,103 filed on Sep. 18, 2023, and U.S. Provisional Patent Application No. 63/629,113 filed on Sep. 21, 2023, which are hereby incorporated by reference herein.

### TECHNICAL FIELD

Embodiments disclosed herein can relate to methods, systems, and media for connecting users to accident services.

### BACKGROUND

When a user with a mobile phone is in a vehicle that is involved in collision (e.g., a collision with another vehicle, person, roadside object, etc.), the user may become so disoriented that the user needs guidance as to what services (e.g., medical services, legal services, towing services, etc.) to contact after the collision has occurred.

There is a need for mechanisms (which can include systems, methods, and/or media) that can determine when a collision has occurred, and mechanisms that can present a user with at least contact information for service providers based at least on geographical location information of the user's device so that the user can more quickly request any necessary medical services, legal services, towing services, etc.

### SUMMARY

This summary is provided to introduce a variety of concepts and/or aspects in a simplified form that is further disclosed in the detailed description, below. This summary is not intended to identify key or essential inventive concepts of the claimed subject matter, nor is it intended for determining the scope of the claimed subject matter.

A system of one or more computing devices can be configured to perform particular processes by virtue of having software, firmware, hardware, or a combination thereof installed on the system that in operation causes or cause the system to perform the processes.

In some embodiments, a system for connecting users to accident services can include memory; and one or more processors configured at least to: generate sensor information based at least on one or more outputs of one or more sensors of a user device, the sensor information including accelerometer information; in response to generating the sensor information, determine that the user device was involved in a collision based at least on the sensor information; determine geographical location information of the user device; in response to determining that the user device was involved in the collision and in response to determining geographical location information of the user device, cause at least contact information for one or more service providers to be presented on the user device based at least in part on the geographical location information of the user device.

In some embodiments, the one or more processors can be configured to perform any processes or subprocesses disclosed herein.

In some embodiments, a method for connecting users to accident services can include generating sensor information based at least on one or more outputs of one or more sensors of a user device, the sensor information including accelerometer information; in response to generating the sensor information, determining that the user device was involved in a collision based at least on the sensor information; determining geographical location information of the user device; in response to determining that the user device was involved in the collision and in response to determining geographical location information of the user device, causing at least contact information for one or more service providers to be presented on the user device based at least in part on the geographical location information of the user device.

In some embodiments, the method can include any processes or subprocesses disclosed herein.

In some embodiments, a non-transitory computer-readable medium can comprise instructions, that when executed by one or more processors, cause the one or more processors to perform a method for connecting users to accident services, the method comprising: generating sensor information based at least on one or more outputs of one or more sensors of a user device, the sensor information including accelerometer information; in response to generating the sensor information, determining that the user device was involved in a collision based at least on the sensor information; determining geographical location information of the user device; in response to determining that the user device was involved in the collision and in response to determining geographical location information of the user device, causing at least contact information for one or more service providers to be presented on the user device based at least in part on the geographical location information of the user device.

In some embodiments, the method performed by the one or more processors can include any processes or subprocesses disclosed herein.

### BRIEF DESCRIPTION OF THE DRAWINGS

A complete understanding of the present features or aspects and the advantages and features thereof will be more readily understood by reference to the following detailed description when considered in conjunction with the accompanying drawings wherein:

FIG. 1 illustrates a block diagram of a system for connecting users to accident services, according to some embodiments disclosed herein;

FIG. 2 illustrates a block diagram of a computing device for connecting users to accident services, according to some embodiments disclosed herein;

FIG. 3A illustrates a diagram of a user device positioned inside a vehicle during a collision with another vehicle, according to some embodiments disclosed herein;

FIG. 3B illustrates a diagram of a user device positioned inside a vehicle during a collision with another vehicle, according to some embodiments disclosed herein;

FIG. 4A illustrates a user interface presented by a user device, according to some embodiments disclosed herein;

FIG. 4B illustrates a user interface presented by a user device, according to some embodiments disclosed herein;

FIG. 5 illustrates a flow diagram of a process for connecting users to accident services, according to some embodiments disclosed herein; and

FIG. 6 illustrates a flow diagram of a process for determining if a user device was involved in a collision, according to some embodiments disclosed herein.

### DETAILED DESCRIPTION

Any specific details of features or aspects are used for demonstration purposes only, and no unnecessary limitations or inferences are to be understood therefrom.

Before describing in detail exemplary aspects, it is noted that the aspects reside primarily in combinations of components and procedures related to the systems, methods, and media disclosed herein. Accordingly, the systems, methods, and media components and processes have been represented where appropriate by conventional symbols in the drawings, showing only those specific details that are pertinent to understanding the aspects of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship, or order between such entities or elements. Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary aspects of the inventive concepts defined in the appended claims. Hence, specific steps, process order, dimensions, component connections, and other physical characteristics relating to the aspects disclosed herein are not to be considered as limiting, unless the claims expressly state otherwise. The use or mention of any single element contemplates a plurality of such element, and the use or mention of a plurality of any element contemplates a single element (for example, “a device” and “devices” and “a plurality of devices” and “one or more devices” and “at least one device” contemplate each other), regardless of whether particular variations are identified and/or described, unless impractical, impossible, or explicitly limited.

Mechanisms (which can include systems, methods, media, or any combination thereof), for connecting user devices to accident services are disclosed herein. In some embodiments, the mechanisms can determine if a user device was involved in a collision, and in response to determining that the user device was involved in the collision, mechanisms disclosed herein can cause at least contact information for service providers to be presented on the user device based at least on geographical location information of the user device and geographical location information of the service providers.

In some embodiments, the mechanisms disclosed herein can determine if a user device was involved in a collision based at least on sensor information generated by one or more sensors of the user device. The one or more sensors can include any suitable sensors such as, for example, one or more accelerometers, one or more gyroscope sensors, one or more microphones, or a combination thereof.

In some embodiments, the one or more accelerometers can detect any changes in velocity of the user device. A larger change in velocity of the user device can indicate that the user device was more likely involved in a collision.

In some embodiments, the one or more accelerometers can include one or more vibration sensors that can detect any vibrations in the user device. Vibrations having higher frequencies or larger amplitudes can indicate that the user device was more likely involved in a collision.

In some embodiments, the one or more gyroscope sensors can detect changes in an angular velocity of the user device. A larger change in the angular velocity of the user device can indicate that the user device was more likely involved in a collision.

In some embodiments, the one or more microphones can detect any sound surrounding the user device. Detected sounds having larger amplitudes or higher frequencies can indicate that the user device was more likely involved in a collision.

In some embodiments, in response to determining that the user device was involved in a collision, the mechanisms disclosed herein can cause at least contact information for one or more service providers to be presented on the user device. In response to receiving a selection of contact information for any service provider, the mechanisms disclosed herein can connect the user device to the service provider so that the user device can request any necessary service (e.g., medical service, legal service, towing service, etc.) from the service provider.

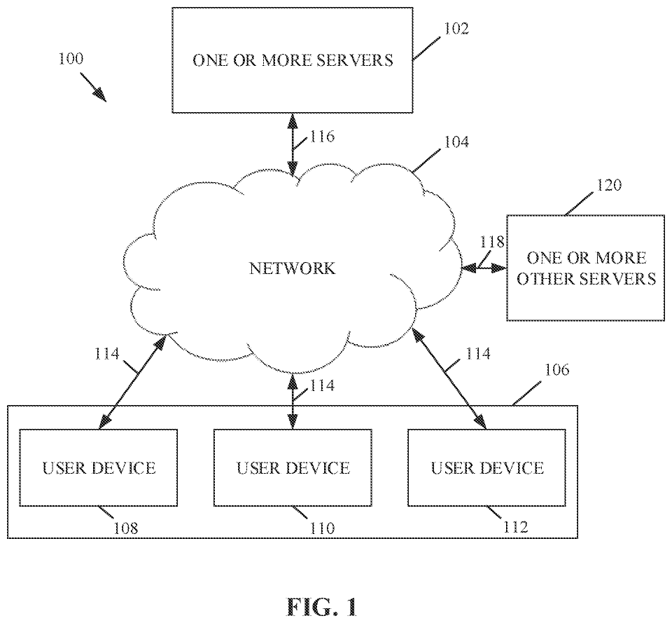

Referring to FIG. 1, a system 100 for connecting users to accident services can be used with some embodiments disclosed herein. In some embodiments, system 100 can comprise one or more servers 102, a network 104 (e.g., communication network), one or more user devices 106, one or more other servers 120, or any combination thereof. In some embodiments, the one or more user devices 106 can include a first user device 108, a second user device 110, a third user device 112, or any combination thereof.

The one or more servers 102 can be any suitable server(s) for storing data, programs, or a combination thereof, for connecting one or more user devices 106 to accident services. In some embodiments, the one or more servers 102 can include one or more computing devices. In some embodiments, the one or more servers 102 can store any suitable data about one or more service providers. For example, the data about the one or more service providers can include contact information for one or more service providers. The contact information for one or more service providers can include the names of any persons associated with the one or more service providers, the business names associated with the one or more service providers, mailing addresses, residential addresses, email addresses, phone numbers (e.g., mobile phone numbers, office phone numbers, etc.), fax numbers, website universal resource locators (website URLs), any other suitable contact information about the one or more service providers, or any combination thereof. In some embodiments, the data about the one or more service providers can include geographical location information about the one or more service providers. The geographical location information can include at least approximate geographical coordinates of the one or more service providers. In some embodiments, the data about the one or more service providers can include any suitable images, videos, or other media associated with the one or more service providers.

The one or more other servers 120 can be any suitable server(s) for storing data, programs, or a combination thereof, for any service requests received from any of the one or more user devices 106 and/or the one or more servers 102. In some embodiments, the one or more other servers 120 can be controlled by respective service providers (e.g., medical service providers, legal service providers, towing service providers, etc.). In some embodiments, the medical service providers can include emergency service providers, such as, for example, emergency medical technicians, firefighters, etc. In some embodiments, the one or more other servers 120 can receive requests for service from the one or more servers 102 and/or the one or more user devices 106, and send responses to the requests for service to the one or more servers 102 and/or the one or more user devices 106.

The network 104 can include a wired network, a wireless network, or a combination thereof. In some embodiments, the network 104 can include the Internet, an intranet, a wide-area network (WAN), a local-area network (LAN), a digital subscriber line (DSL) network, a frame relay network, an asynchronous transfer mode (ATM) network, a virtual private network (VPN), any other suitable communication network, or any combination thereof. In some embodiments, one or more communications links 114 can connect the one or more user devices 106 to the network 104. In some embodiments, one or more communication links 116 can connect the network 104 to the one or more servers 102. In some embodiments, one or more communication links 118 can connect the network 104 to the one or more other servers 120. The one or more communication links 114, 116, 118 can be any communication links suitable for communicating information between the one or more user devices 106, the one or more servers 102, and the one or more other servers 120, such as, for example, network links, dial-up links, wireless links, hard-wired links, any other suitable communications links, or any combination thereof.

The one or more user devices 106 can be configured to request any data about one or more service providers from the one or more servers 102, and receive any data about one or more service providers from the one or more servers 102. For example, in some embodiments, the one or more user devices 106 can include one or more computing devices. The one or more computing devices can include a mobile device, such as a mobile phone, a tablet computer, a wearable computer, a laptop computer, a vehicle (e.g., a car, a boat, an airplane, or any other suitable vehicle), any other suitable mobile device, any suitable non-mobile device (e.g., a desktop computer, entertainment system, etc.), or any combination thereof. As another example, the one or more computing devices can include a media playback device, such as a television, a projector device, a game console, any other suitable computing device, or any combination thereof.

While the one or more servers 102 are illustrated as one device, the processes performed by the one or more servers 102 can be performed by any suitable number of computing devices in some embodiments.

Although three user devices 108, 110, 112 are shown in FIG. 1 to avoid over-complicating the figure, any suitable number of user devices can be used in some embodiments.

In some embodiments, the one or more servers 102 and the one or more user devices 106 can be implemented using any suitable hardware. For example, any device of the one or more servers 102, the one or more user devices 106, and the one or more other servers 120 can be implemented using any suitable general-purpose computer or special-purpose computer. Any general-purpose computer or special-purpose computer can include any suitable hardware.

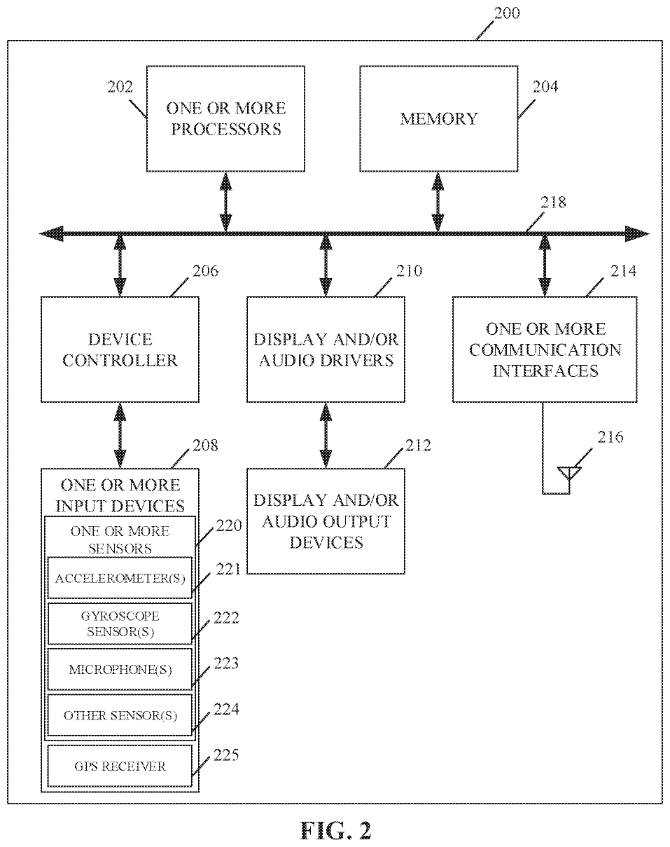

Referring to FIG. 2, an example hardware of a computing device 200 is illustrated. In some embodiments, the computing device 200 can include one or more processors 202, memory 204, a device controller 206, one or more input devices 208, display and/or audio drivers 210, display and/or audio output devices 212, one or more communication interfaces 214, one or more antennas 216, a bus 218, or any combination thereof.

In some embodiments, the one or more processors 202 can include any suitable hardware processor, such as a central processing unit (CPU), a graphics processing unit (GPU), a tensor processing unit (TPU), an accelerated processing unit (APU), any other type of processing unit, or any combination thereof. In some embodiments, the one or more processors 202 can include a microprocessor, a micro-controller, a digital signal processor, dedicated logic, an application-specific integrated circuit (ASIC), a field programmable gate array (FPGA), an accelerator (e.g., an artificial intelligence (AI) accelerator or a cryptographic accelerator), any other suitable circuitry for controlling the functioning of a general purpose computer or a special purpose computer, or any combination thereof.

In some embodiments, one or more processors 202 of any server of the one or more servers 102 can be controlled by a server program stored in memory 204 of the server. For example, in some embodiments, the server program can cause the one or more processors 202 to store any data about one or more service providers in any suitable files with associated information, send the data about the one or more service providers to the one or more user devices 106 in response to receiving, from the one or more user devices 106, one or more requests for the data about the one or more service providers, receive requests for service from the one or more user devices 106, send requests for service to the one or more other servers 120, receive responses to the requests for service from the one or more other servers 120, send the responses to the requests for service to the one or more user devices 106, any other suitable process disclosed herein, or any combination thereof.

In some embodiments, one or more processors 202 of any user device (e.g., 108, 110, 112 in FIG. 1) of the one or more user devices 106 can be controlled by a computer program stored in memory 204 of the user device. For example, the computer program can cause the one or more processors 202 to request any data about one or more service providers from the one or more servers 102, receive any data about one or more service providers from the one or more servers 102, send requests for service to the one or more servers 102 and/or the one or more other servers 120, receive responses to requests from the one or more servers 102 and/or the one or more other servers 120, any other suitable process disclosed herein, or any combination thereof.

In some embodiments, the memory 204 can include any suitable memory, storage, or a combination thereof for storing programs, data, and/or any other suitable information. For example, memory 204 can include volatile memory, non-volatile memory, or any combination thereof. In some embodiments, memory 204 can include random access memory, read-only memory, flash memory, a hard disk drive, a solid state drive, optical media, any other suitable memory, or any combination thereof.

In some embodiments, the device controller 206 can include any suitable processor or circuitry for controlling and receiving any input from the one or more input devices 208. In some embodiments, the one or more input devices 208 can include a touchscreen, a keyboard, a mouse, one or more buttons, a voice recognition circuit, a camera, one or more sensors 220, a global positioning system (GPS) receiver 225, any other suitable input device, or any combination thereof. In some embodiments, the one or more sensors 220 can include one or more accelerometers 221, one or more gyroscope sensors 222, one or more microphones 223, any other suitable sensors 224 (e.g., an optical sensor, a temperature sensor, a near field sensor), or any combination thereof. The GPS receiver 225 can be configured to receive any signals from GPS satellites so that the computing device 200 can determine geographical location information of the computing device 200 using, for example, multilateration (including e.g., trilateration). The signals from the GPS satellites can contain information about the satellites' positions and the times at which the signals were sent which can be used to determine the geographical location information of the computing device 200. In some embodiments, the one or more input devices 208 can be included in any device of the one or more servers 102, the one or more user devices 106, or any combination thereof.

In some embodiments, the display and/or audio drivers 210 can include any suitable circuitry for controlling and driving output to one or more display and/or audio output devices 212. For example, the output devices can include a display (e.g., including a touchscreen, a flat-panel display, a cathode ray tube display, a projector, any other suitable display or presentation device, or any combination thereof), one or more speakers, or a combination thereof.

In some embodiments, the one or more communication interfaces 214 can include any suitable circuitry for interfacing with one or more communication networks, such as network 104 as shown in FIG. 1. For example, the one or more communication interfaces 214 can include network interface card circuitry, wired communication circuitry, wireless communication circuitry, any other suitable communication network circuitry, or any combination thereof.

In some embodiments, the one or more antennas 216 can wirelessly communicate with a communication network (e.g., network 104). In some embodiments, the one or more antennas 216 can be omitted.

In some embodiments, the bus 218 can include any suitable communication system for communicating data, addresses, control signals, power, or any combination thereof, between two or more components 202, 204, 206, 210, and 214. In some embodiments, the bus 218 can include any suitable conductors that are constructed and arranged to communicate data, addresses, control signals, power, or any combination thereof, between two or more components 202, 204, 206, 210, and 214.

In some embodiments, any other suitable component(s) can be included in the computing device 200.

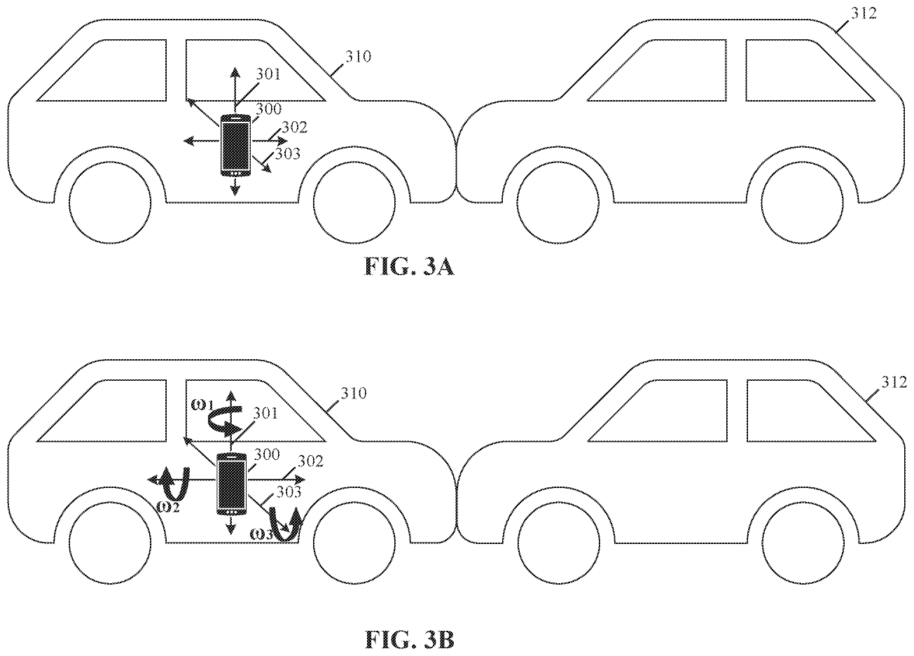

Referring to FIG. 3A, a computing device such as a user device 300 can be positioned inside a first vehicle 310 that is involved in a collision with a second vehicle 312. One or more accelerometers (e.g., 221 in FIG. 2) of the user device 300 can be configured at least to detect and/or measure any acceleration (i.e., change in velocity) of the user device 300 along a first axis 301, a second axis 302, a third axis 303, or any combination thereof. In some embodiments, the first axis 301 can be perpendicular to the second axis 302 and the third axis 303. In some embodiments, the second axis 302 can be perpendicular to the third axis 303.

In some embodiments, the one or more accelerometers can be configured to output one or more electrical signals conveying sensor information that indicates any acceleration of the user device 300 along the first axis 301, the second axis 302, the third axis 303, or any combination thereof.

In some embodiments, the one or more accelerometers can be configured to at least output a first current or voltage value indicating a first acceleration of the user device 300 along the first axis 301. In some embodiments, the one or more accelerometers can be configured to at least output a second current or voltage value indicating a second acceleration of the user device 300 along the second axis 302. In some embodiments, the one or more accelerometers can be configured to at least output a third current or voltage value indicating a third acceleration of the user device 300 along the third axis 303. In some embodiments, the first current or voltage value, the second current or voltage value, and the third current or voltage value can be used as acceleration values, or the user device 300 can determine acceleration values based at least on the first current or voltage value, the second current or voltage value, the third current or voltage value, or any combination thereof.

As the first vehicle 310 was travelling in a direction along the second axis 302 before colliding with the second vehicle 312, the magnitude of the acceleration of the user device 300 along the second axis 302 can be higher than a suitable acceleration threshold (e.g., 2g or higher, where g is gravitational acceleration due to Earth's gravity), which can indicate that the first vehicle 310 and the user device 300 inside the first vehicle 310 were involved in a collision.

Referring to FIG. 3B one or more gyroscope sensors (e.g., 222 in FIG. 2) of the user device 300 can be configured to output one or more electrical signals conveying sensor information that indicates any angular velocities of the user device 300 rotating about a first axis 301, a second axis 302, a third axis 303, or any combination thereof.

In some embodiments, the one or more gyroscope sensors can be configured to at least output a first current or voltage value indicating a first angular velocity ω₁ of the user device 300 with respect to the first axis 301. In some embodiments, the one or more gyroscope sensors can be configured to at least output a second current or voltage value indicating a second angular velocity ω₂ of the user device 300 with respect to the second axis 302. In some embodiments, the one or more gyroscope sensors can be configured to at least output a third current or voltage value indicating a third angular velocity ω₃ of the user device 300 with respect to the third axis 303. In some embodiments, the first current or voltage value, the second current or voltage value, and the third current or voltage value can be used as angular velocity values, or the user device 300 can determine angular velocity values based at least on the first current or voltage value, the second current or voltage value, the third current or voltage value, or any combination thereof.

When the first vehicle 310 collides with the second vehicle 312, the user device 300 can collide with objects inside the first vehicle, causing the user device 300 to have at least one angular velocity value that is higher than an angular velocity threshold, which can indicate that the first vehicle 310 and the user device 300 inside the first vehicle 310 were involved in a collision. Additionally or alternatively, when the first vehicle 310 collides with the second vehicle 312, any sound amplitudes or frequencies detected by one or more microphones (e.g., 223 in FIG. 2) of the user device 300 can be measured as being higher than corresponding thresholds, indicating that the first vehicle 310 and the user device 300 inside the first vehicle 310 were involved in a collision.

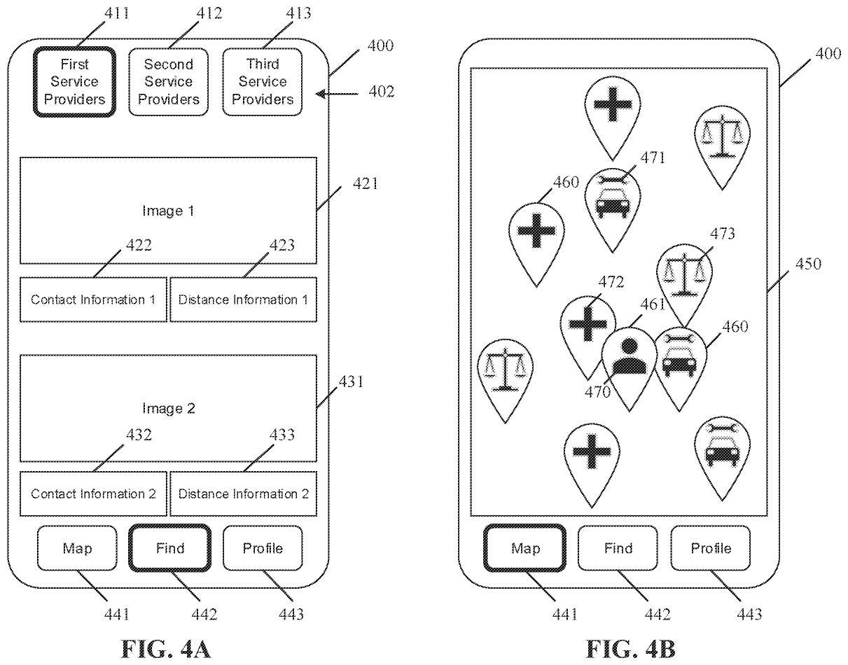

Referring to FIG. 4A, after determining that a user device (e.g., 300 in FIGS. 3A and 3B) was involved in a collision, the user device can cause a user interface 400 to be presented. The user interface 400 can include one or more selectable icons 402 for different groups of service providers. The one or more selectable icons 402 can include a first selectable icon 411 that, when selected, causes images and/or information for a first group of service providers that provide a first type of service (e.g., medical service providers) to be presented. The one or more selectable icons 402 can include a second selectable icon 412 that, when selected, causes images and/or information for a second group of service providers that provide a second type of service (e.g., legal service providers) to be presented. The one or more selectable icons 402 can include a third selectable icon 413 that, when selected, causes images and/or information for a third group of service providers that provide a third type of service (e.g., legal service providers) to be presented.

In some embodiments, the user device 300 can cause at least contact information for the first group of service providers to be presented. In some embodiments, a first service provider (e.g., a specific company) can create a first service provider user account that is associated with the first group of service providers. The first service provider user account can additionally be associated with a first image 421, first contact information 422, and first distance information 423 associated with the first service provider. In response to receiving a selection of the first selectable icon 411, the first image 421, the first contact information 422, and the first distance information 423 associated with the first service provider can be presented on the user interface 400. The first distance information 423 can indicate a distance between the user device 300 and the first service provider.

Any suitable number of images and instances of information can be presented on the user interface 400 in response to the user device receiving a selection of an icon such as the first selectable icon 411. For example, a second service provider (e.g., another specific company) can create a second service provider user account that is associated with the first group of service providers. The second service provider user account can additionally be associated with a second image 431, second contact information 432, and second distance information 433 associated with the second service provider. In response to receiving a selection of the first selectable icon 411, the second image 431, the second contact information 432, and the second distance information 433 associated with the second service provider can be presented on the user interface 400.

Referring to FIG. 4B, in response to receiving a selection of a map icon 441, the user interface 400 can include a map 450 and positional indicators 460 thereon. The map can represent a geographical area, and can include any suitable geographical features, structures, landmarks, etc. In some embodiments, the positional indicators 460 can indicate at least approximate locations of corresponding service providers within a predetermined distance (e.g., 1 mile, 2 miles, 3 miles, etc.) from a geographical location of the user device, or at least an approximate location of the user device presenting the user interface 400. Service provider icons 471, 472, and 473 on respective positional indicators can indicate that the positional indicators are for different types of service providers. The locations of the service providers can be provided by the service providers upon registering user accounts. In some embodiments, a positional indicator 461 of the user device presenting the user interface 400 can be presented on the map 450. The positional indicator 461 can include a user icon 470 that indicates the positional indicator is for the user device presenting the user interface 400. The at least approximate location of the user device can be determined using any suitable method or system, such as, for example, a global positioning system (GPS), multilateration, cellular triangulation, Wi-Fi positioning, internet protocol geolocation, etc.

To cause any images or instances of information about service providers to be presented, a user can select the find icon 442 which can cause images 421, 431, contact information 422, 432, and distance information 423, 433, such as is illustrated in FIG. 4A, to be presented. To cause any information about the user account of the user operating the user device to be presented, the user can select the profile icon 443.

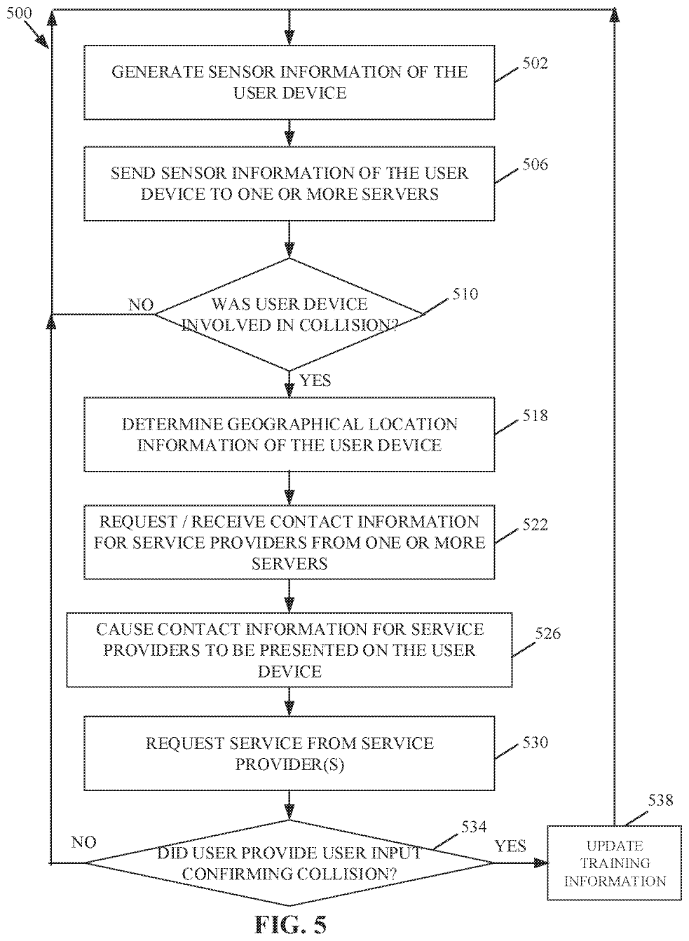

Referring to FIG. 5, a flow diagram of a process 500 for connecting users to accident services is illustrated. In some embodiments, the process 500 can generate 502, by one or more sensors of a user device, sensor information. In some embodiments, the sensor information can include accelerometer information from one or more accelerometers (e.g., 221 in FIG. 2). In some embodiments, the accelerometer information can indicate any acceleration of the user device along one or more directions or axes (e.g., 301, 302, 303 in FIGS. 3A and 3B). In some embodiments, one or more accelerometer values that indicate the acceleration of the user device along one or more directions or axes can be determined based at least on the accelerometer information.

In some embodiments, the sensor information can include angular velocity information from one or more gyroscope sensors (e.g., 222 in FIG. 2), wherein the angular velocity information indicates any angular velocity of the user device with respect to one or more directions or axes. In some embodiments, one or more angular velocity values that indicate the angular velocity of the user device with respect to one or more directions or axes can be determined based at least on the angular velocity information.

In some embodiments, the sensor information can include audio information from one or more microphones (e.g., 223 in FIG. 2). In some embodiments, the audio information can indicate amplitudes and frequencies of sound detected by the one or more microphones.

In some embodiments, in response to generating the sensor information, the process 500 can send 506 the sensor information of the user device to one or more servers (e.g., 102 in FIG. 1) for processing if desired.

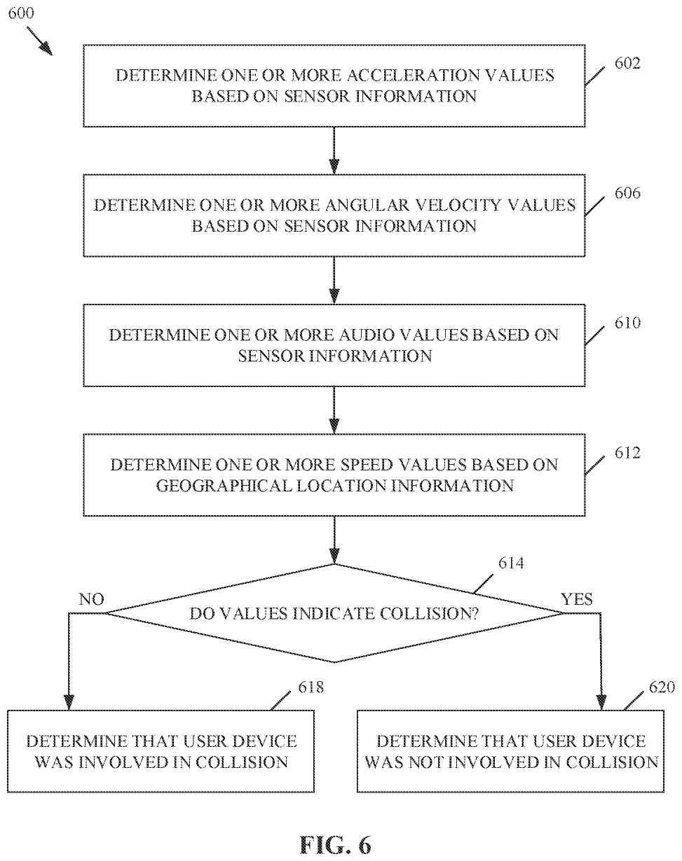

In some embodiments, in response to generating 502 the sensor information, the process 500 can determine 510 if the user device was involved in a collision based at least on the sensor information and any values determined based at least on the sensor information. Determining 510 if the user device was involved in a collision can be performed using any suitable process, such as, for example, process 600 in FIG. 6. In some embodiments, the one or more servers can perform subprocess 510 after receiving the sensor information.

In some embodiments, in response to determining 510 that the user device was not involved in a collision, the process 500 can return to generating 502 sensor information.

In some embodiments, the process 500 can determine 518 geographical location information of the user device. In some embodiments, the geographical location information can include any information indicating the geographical location of the user device, such as, for example, geographical coordinates (e.g., longitude, latitude), the zip code, city, state, country, etc. The geographical location information can be generated using any suitable method, such as, for example, communicating with a global positioning system (GPS) using a GPS receiver (e.g., 225 in FIG. 2) of the user device.

In some embodiments, in response to determining 510 that the user device was involved in the collision and in response to determining 518 geographical location information of the user device, the process 500 can 522 request any suitable information including at least contact information for one or more service providers from one or more servers. In response to receiving the request, the one or more servers can send information about one or more service providers to the user device and the user device can receive at least the contact information for one or more service providers.

In some embodiments, in response to determining 510 that the user device was involved in the collision and in response to determining 518 geographical location information of the user device, the process 500 can cause 526 at least contact information for one or more service providers to be presented on the user device based at least in part on the geographical location information of the user device, the geographical location information of the one or more service providers, or any combination thereof. In some embodiments, geographical locations of the one or more service providers whose contact information is shown are within a predetermined distance (e.g., 1 mile, 2 miles, 3 miles, etc.) from a geographical location of the user device.

A user of the user device can provide user input to request services from any service providers. In response to receiving the user input and/or in response to determining that the user device was involved in the collision, the process 500 can request 530 service from one or more service providers. In some embodiments, the user device can request service by sending any necessary requests for service to one or more servers (e.g., 102 in FIG. 1) and/or one or more other servers (e.g., 120 in FIG. 1) of the one or more service providers, by initiating a phone call with any service providers, or using any other suitable method. In some embodiments, requesting 530 service from the one or more service providers can include sending the geographical location information of the user device to one or more servers (e.g., 102 in FIG. 1) and/or to one or more other servers (e.g., 120 in FIG. 1) of the one or more service providers.

In some embodiments, the process 500 can request 534 user input to confirm that the user device was involved in a collision. In some embodiments, the one or more servers can send a request to the user device to request the user input, and the user device can request 534 the user input from a user. In response to a user providing user input, the process 500 can receive the user input confirming that the user device was involved in a collision or confirming that the user device was not involved in a collision.

In some embodiments, if the user provided user input, the process 500 can update 538 training information used in a machine classifier further described with respect to FIG. 6 based at least on the user input. In response, the process 500 can return to generating 502 sensor information.

In some embodiments, if the user provides no user input within a predetermined amount of time, the process 500 can determine that no user input was received within a predetermined amount of time after causing at least the contact information for the one or more service providers to be presented on the user device. In response to determining that no user input was received within the predetermined amount of time, the process can cause the contact information for the one or more service providers to not be presented on the user device, and return to generating 502 sensor information.

Referring to FIG. 6, a flow diagram of a process 600 for determining if a user device was involved in a collision is shown. In some embodiments, if sensor information includes accelerometer information and if the one or more sensors include one or more accelerometers, the process 600 can determine 602 one or more acceleration values based at least on the accelerometer information from one or more accelerometers of the user device.

In some embodiments, if the sensor information includes angular velocity information and if the one or more sensors include one or more gyroscope sensors, the process 600 can determine 606 one or more angular velocity values based at least on the angular velocity information from the one or more gyroscope sensors of the user device.

In some embodiments, if the sensor information includes audio information and if the one or more sensors include one or more microphones, the process 600 can determine 610 one or more audio values based at least on the audio information from the one or more microphones of the user device. In some embodiments, the audio values can include audio amplitude values, audio frequency values, audio wavelength values, or any combination thereof, of any sounds detected by the one or more microphones of the user device.

In some embodiments, the process 600 can determine 612 one or more speed values of the user device based on changes of the geographical location information of the user device over time. In some embodiments, the geographical location of the user device changing more over time can indicate that the user device is travelling at a faster speed, which can indicate that the user device is positioned inside a vehicle (e.g., a motor vehicle) that could potentially be involved in a collision.

In some embodiments, the process 600 can determine 614 if the values indicate that the user device was involved in a collision. Determining 614 if the values indicate that the user device was involved in a collision can be performed using any suitable process. For example, in some embodiments, each value (e.g., an acceleration value, angular velocity value, audio value, speed value, etc.) can be compared to a corresponding threshold (e.g., an acceleration threshold, angular velocity threshold, audio threshold, speed threshold, etc.) to determine if the value indicates that the user device was involved in a collision. If the value meets a corresponding threshold (e.g., by being greater than the corresponding threshold), the process 600 can determine 618 that the user device was involved in a collision. Otherwise, the process 600 can determine 620 that the user device was not involved in a collision.

In some embodiments, the values can be compared to corresponding thresholds to determine if a count of the values (e.g., 1 value, 2 values, 3 values, etc.) meeting corresponding thresholds meets a count threshold. If the count of the values meeting corresponding thresholds meets a count threshold, the process 600 can determine 618 that the user device was involved in a collision. Otherwise, the process 600 can determine 620 that the user device was not involved in a collision.

In some embodiments, determining 614 if the values indicate that the user device was involved in a collision can be performed using any suitable artificial intelligence models and any suitable training information. In some embodiments, suitable artificial intelligence models can include one or more machine learning classifiers including, for example, a decision tree, a random forest, a support vector machine, a K-nearest neighbors classifier, a Bayes classifier, logistic regression, a neural network (e.g., a convolutional neural network, a recurrent neural network, etc.), any other suitable artificial intelligence model(s), or any combination thereof. In some embodiments, the training information can include historical sensor information detected by the one or more sensors of one or more user devices or historical geographical location information of one or more user devices. In some embodiments, the training information (including e.g., any thresholds or weights) can be updated based at least on any user inputs confirming that collisions occurred after determining that user devices were involved in collisions, any user inputs confirming that collisions did not occur after determining that user devices were involved in collisions, any values determined before determining that user devices were involved in collisions, or any combination thereof.

The following description of variants is only illustrative of components, elements, acts, systems, media, and methods considered to be within the scope of the invention and are not in any way intended to limit such scope by what is specifically disclosed or not expressly set forth. The components, elements, acts, systems, media, and methods as described herein may be combined and rearranged other than as expressly described herein and are still considered to be within the scope of the invention.

According to variation 1, a system for connecting users to accident services can include memory; and one or more processors configured at least to: generate sensor information based at least on one or more outputs of one or more sensors of a user device, the sensor information including accelerometer information; in response to generating the sensor information, determine that the user device was involved in a collision based at least on the sensor information; determine geographical location information of the user device; in response to determining that the user device was involved in the collision and in response to determining geographical location information of the user device, cause at least contact information for one or more service providers to be presented on the user device based at least in part on the geographical location information of the user device.

Variation 2 can include the system of variation 1, wherein the one or more sensors include one or more accelerometers, one or more gyroscope sensors, or a combination thereof.

Variation 3 can include the system of variation 1, wherein the user device is a mobile phone.

Variation 4 can include the system of variation 1, wherein the one or more processors are further configured to: determine that no user input was received within a predetermined amount of time after causing at least the contact information for the one or more service providers to be presented on the user device; and in response to determining that no user input was received within the predetermined amount of time, cause the contact information for the one or more service providers to not be presented on the user device.

Variation 5 can include the system of variation 1, wherein determining that the user device was involved in the collision comprises: determining one or more acceleration values based on the sensor information; determining that at least one acceleration value of the one or more acceleration values meets an acceleration threshold; and in response to determining that the at least one acceleration value of the one or more acceleration values meets the acceleration threshold, determining that the user device was involved in the collision.

Variation 6 can include the system of variation 1, wherein the one or more service providers include a towing service provider or a medical service provider.

Variation 7 can include the system of variation 1, wherein the one or more processors are further configured to: send geographical location information of the user device to at least one computing device of the one or more service providers.

According to variation 8, a method for connecting users to accident services can include generating sensor information based at least on one or more outputs of one or more sensors of a user device, the sensor information including accelerometer information; in response to generating the sensor information, determining that the user device was involved in a collision based at least on the sensor information; determining geographical location information of the user device; in response to determining that the user device was involved in the collision and in response to determining geographical location information of the user device, causing at least contact information for one or more service providers to be presented on the user device based at least in part on the geographical location information of the user device.

Variation 9 can include the method of variation 8, wherein the one or more sensors include one or more accelerometers, one or more gyroscope sensors, or a combination thereof.

Variation 10 can include the method of variation 8, wherein the user device is a mobile phone.

Variation 11 can include the method of variation 8, further comprising: determining that no user input was received within a predetermined amount of time after causing at least the contact information for the one or more service providers to be presented on the user device; and in response to determining that no user input was received within the predetermined amount of time, causing the contact information for the one or more service providers to not be presented on the user device.

Variation 12 can include the method of variation 8, wherein determining that the user device was involved in the collision comprises: determining one or more acceleration values based on the sensor information; determining that at least one acceleration value of the one or more acceleration values meets an acceleration threshold; and in response to determining that the at least one acceleration value of the one or more acceleration values meets the acceleration threshold, determining that the user device was involved in the collision.

Variation 13 can include the method of variation 8, wherein the one or more service providers include a towing service provider or a medical service provider.

Variation 14 can include the method of variation 8, further comprising: sending geographical location information of the user device to at least one computing device of the one or more service providers.

According to variation 15, a non-transitory computer-readable medium can comprise instructions, that when executed by one or more processors, cause the one or more processors to perform a method for connecting users to accident services, the method comprising: generating sensor information based at least on one or more outputs of one or more sensors of a user device, the sensor information including accelerometer information; in response to generating the sensor information, determining that the user device was involved in a collision based at least on the sensor information; determining geographical location information of the user device; in response to determining that the user device was involved in the collision and in response to determining geographical location information of the user device, causing at least contact information for one or more service providers to be presented on the user device based at least in part on the geographical location information of the user device.

Variation 16 can include the non-transitory computer-readable medium of variation 15, wherein the one or more sensors include one or more accelerometers, one or more gyroscope sensors, or a combination thereof.

Variation 17 can include the non-transitory computer-readable medium of variation 15, wherein the method further comprises: determining that no user input was received within a predetermined amount of time after causing at least the contact information for the one or more service providers to be presented on the user device; and in response to determining that no user input was received within the predetermined amount of time, causing the contact information for the one or more service providers to not be presented on the user device.

Variation 18 can include the non-transitory computer-readable medium of variation 15, wherein determining that the user device was involved in the collision comprises: determining one or more acceleration values based on the sensor information; determining that at least one acceleration value of the one or more acceleration values meets an acceleration threshold; and in response to determining that the at least one acceleration value of the one or more acceleration values meets the acceleration threshold, determining that the user device was involved in the collision.

Variation 19 can include the non-transitory computer-readable medium of variation 15, wherein the one or more service providers include a towing service provider or a medical service provider.

Variation 20 can include the non-transitory computer-readable medium of variation 15, wherein the method further comprises: sending geographical location information of the user device to at least one computing device of the one or more service providers.

It will be understood that it would be unduly repetitious and obfuscating to describe and illustrate every reordering, combination and subcombination of the elements and the aspects described. Accordingly, all elements, processes, and subprocesses can be combined in any way and/or combination, and the present specification, including the drawings, shall be construed to constitute a complete written description of all reorderings, combinations and subcombinations of the elements, processes, and subprocesses and of the aspects described herein, and of the manner and process of making and using the elements, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for connecting users to accident services, comprising:
memory; and
one or more processors configured at least to:
generate sensor information based at least on one or more outputs of one or more sensors of a user device, the sensor information including accelerometer information;
in response to generating the sensor information, determine that the user device was involved in a collision based at least on the sensor information;
determine geographical location information of the user device;
in response to determining that the user device was involved in the collision and in response to determining geographical location information of the user device, cause at least contact information for one or more service providers to be presented on the user device based at least in part on the geographical location information of the user device.

2. The system of claim 1, wherein the one or more sensors include one or more accelerometers, one or more gyroscope sensors, or a combination thereof.

3. The system of claim 1, wherein the user device is a mobile phone.

4. The system of claim 1, wherein the one or more processors are further configured to:
determine that no user input was received within a predetermined amount of time after causing at least the contact information for the one or more service providers to be presented on the user device; and
in response to determining that no user input was received within the predetermined amount of time, cause the contact information for the one or more service providers to not be presented on the user device.

5. The system of claim 1, wherein determining that the user device was involved in the collision comprises:
determining one or more acceleration values based on the sensor information;
determining that at least one acceleration value of the one or more acceleration values meets an acceleration threshold; and
in response to determining that the at least one acceleration value of the one or more acceleration values meets the acceleration threshold, determining that the user device was involved in the collision.

6. The system of claim 1, wherein the one or more service providers include a towing service provider or a medical service provider.

7. The system of claim 1, wherein the one or more processors are further configured to:
send geographical location information of the user device to at least one computing device of the one or more service providers.

8. A method for connecting users to accident services, comprising:
generating sensor information based at least on one or more outputs of one or more sensors of a user device, the sensor information including accelerometer information;
in response to generating the sensor information, determining that the user device was involved in a collision based at least on the sensor information;
determining geographical location information of the user device;
in response to determining that the user device was involved in the collision and in response to determining geographical location information of the user device, causing at least contact information for one or more service providers to be presented on the user device based at least in part on the geographical location information of the user device.

9. The method of claim 8, wherein the one or more sensors include one or more accelerometers, one or more gyroscope sensors, or a combination thereof.

10. The method of claim 8, wherein the user device is a mobile phone.

11. The method of claim 8, further comprising:
determining that no user input was received within a predetermined amount of time after causing at least the contact information for the one or more service providers to be presented on the user device; and
in response to determining that no user input was received within the predetermined amount of time, causing the contact information for the one or more service providers to not be presented on the user device.

12. The method of claim 8, wherein determining that the user device was involved in the collision comprises:
determining one or more acceleration values based on the sensor information;
determining that at least one acceleration value of the one or more acceleration values meets an acceleration threshold; and
in response to determining that the at least one acceleration value of the one or more acceleration values meets the acceleration threshold, determining that the user device was involved in the collision.

13. The method of claim 8, wherein the one or more service providers include a towing service provider or a medical service provider.

14. The method of claim 8, further comprising:
sending geographical location information of the user device to at least one computing device of the one or more service providers.

15. A non-transitory computer-readable medium comprising instructions, that when executed by one or more processors, cause the one or more processors to perform a method for connecting users to accident services, the method comprising:
generating sensor information based at least on one or more outputs of one or more sensors of a user device, the sensor information including accelerometer information;
in response to generating the sensor information, determining that the user device was involved in a collision based at least on the sensor information;
determining geographical location information of the user device;
in response to determining that the user device was involved in the collision and in response to determining geographical location information of the user device, causing at least contact information for one or more service providers to be presented on the user device based at least in part on the geographical location information of the user device.

16. The non-transitory computer-readable medium of claim 15, wherein the one or more sensors include one or more accelerometers, one or more gyroscope sensors, or a combination thereof.

17. The non-transitory computer-readable medium of claim 15, wherein the method further comprises:
determining that no user input was received within a predetermined amount of time after causing at least the contact information for the one or more service providers to be presented on the user device; and
in response to determining that no user input was received within the predetermined amount of time, causing the contact information for the one or more service providers to not be presented on the user device.

18. The non-transitory computer-readable medium of claim 15, wherein determining that the user device was involved in the collision comprises:
determining one or more acceleration values based on the sensor information;
determining that at least one acceleration value of the one or more acceleration values meets an acceleration threshold; and
in response to determining that the at least one acceleration value of the one or more acceleration values meets the acceleration threshold, determining that the user device was involved in the collision.

19. The non-transitory computer-readable medium of claim 15, wherein the one or more service providers include a towing service provider or a medical service provider.

20. The non-transitory computer-readable medium of claim 15, wherein the method further comprises:
sending geographical location information of the user device to at least one computing device of the one or more service providers.
